(19) United States
(12) Patent Application Publication
(10) Pub. No.: US 2011/0175942 A1
(43) Pub. Date: Jul. 21, 2011

(54) Gamma Reference Voltage Output Circuit of Source Driver

(75) Inventors: Yong-Sung Ahn, Ansan-si (KR); Jong-Soo Lee, Cheongju-si (KR)

(73) Assignee: SILICON WORKS CO., LTD, Daejeon-si (KR)

(21) Appl. No.: 13/008,313

(22) Filed: Jan. 18, 2011

(30) Foreign Application Priority Data
Jan. 19, 2010 (KR) 10-2010-0004652

(51) Int. Cl. G09G 5/10

(52) U.S. Cl. 345/690

(57) ABSTRACT

A gamma reference voltage output circuit of a source driver includes a reference voltage generation unit configured to divide power supply voltages by using resistors which are connected in series, and generate a plurality of gamma reference voltages; a gamma buffer unit having a plurality of gamma buffers which selectively output, through internal switching operations, gamma reference voltages needed by a plurality of gamma voltage generation units; and the plurality of gamma voltage generation units configured to divide the gamma reference voltages which are inputted from the gamma buffer unit, by using resistors which are connected in series, in conformity with a required mode and output divided gamma voltages.

### BACKGROUND OF THE INVENTION

1. Field of the Invention

The present invention relates to a technology for outputting a gamma reference voltage in a source driver of a liquid crystal display device, and more particularly, to a gamma reference voltage output circuit of a source driver, which can selectively output gamma reference voltages to an IPS (in-plane switching) gamma voltage generation unit and a TN (twisted nematic) gamma voltage generation unit depending upon a selected mode when outputting the gamma reference voltages from gamma buffers.

2. Description of the Related Art

In general, a liquid crystal display device has a source driver integrated circuit which drives data lines of a liquid crystal display panel according to R, G and B data inputted from an outside.

FIG. 1 is a block diagram illustrating a conventional source driver circuit.

Referring to FIG. 1, the conventional source driver circuit includes a reference voltage generation unit 11, a gamma buffer unit 12, a switch unit 13, a TN (twisted nematic) gamma voltage generation unit 14A, an IPS (in-plane switching) gamma voltage generation unit 14B, a multiplexer 15, and a digital (D)/analog (A) converter 16.

The reference voltage generation unit 11 has resistors R_r which are connected in series, and is configured to divide a voltage difference between power supply voltages Vin1 and Vin2 by the resistors R_r and generate a plurality of gamma reference voltages Vref0 through Vref6.

The gamma buffer unit 12 has a plurality of gamma buffers GB1 through GB7, and is configured to stabilize and output the gamma reference voltages Vref0 through Vref6 which are outputted from the reference voltage generation unit 11.

The gamma buffers GB1 through GB7 are generally realized by operational amplifiers. FIG. 2 illustrates the circuit of the output stage of an operational amplifier. Referring to FIG. 2, the source terminal of a MOS transistor M1 is connected to a power supply terminal VDDP, and the source terminal of a MOS transistor M2 is connected to a ground terminal VSS. The drain terminals of the MOS transistors M1 and M2 are commonly connected to an output terminal OUT. Voltages V1 and V2, which are outputted from a summing stage of a front end, are supplied to the gate terminals of the MOS transistors M1 and M2.

The switch unit 13 has a plurality of switches SW1 through SW7, and is configured to transfer the gamma reference voltages Vref0 through Vref6, which are outputted from the gamma buffer unit 12, to the input stage of the TN gamma voltage generation unit 14A or the input stage of the IPS gamma voltage generation unit 14B.

For example, when a switching control signal CS of a low level is inputted from a controller (for example, a timing controller), movable terminals a1 through a7 of the switches SW1 through SW7 are respectively coupled to fixed terminals b1 through b7. Accordingly, the gamma reference voltages Vref0 through Vref6, which are outputted from the gamma buffers GB1 through GB7, are transmitted to the input stage of the TN gamma voltage generation unit 14A.

Conversely, when the switching control signal CS of a high level is inputted from the controller, the movable terminals a1 through a7 of the switches SW1 through SW7 are coupled to the fixed terminals c1 through c7. Accordingly, the gamma reference voltages Vref0 through Vref6, which are outputted from the gamma buffers GB1 through GB7, are transmitted to the input stage of the IPS gamma voltage generation unit 14B.

Each of the TN gamma voltage generation unit 14A and the IPS gamma voltage generation unit 14B has resistors R_s which are connected in series. The TN gamma voltage generation unit 14A and the IPS gamma voltage generation unit 14B are configured to divide the gamma reference voltages Vref0 through Vref6, which are inputted from the gamma buffer unit 12, in conformity with a TN (twisted nematic) mode and an IPS (in-plane switching) mode, and output divided gamma voltages V_TN<255:0> and V_IPS<255:0>.

The multiplexer 15 is configured to select and output the gamma voltages V_TN<255:0> which are outputted from the TN gamma voltage generation unit 14A or the gamma voltages V_IPS<255:0> which are outputted from the IPS gamma voltage generation unit 14B, according to a mode select signal IPSEN.

The D/A converter 16 is configured to select and output the analog gamma voltages V_TN<255:0> and V_IPS<255:0> which are generated through the paths as described above, in correspondence to R, G and B data which are inputted from the controller.

In this way, the conventional source driver circuit is configured in such a way as to dispose the switch unit outside the output stage of the gamma buffer unit so that the gamma voltages are transmitted to the input stage of the TN gamma voltage generation unit or the input stage of the IPS gamma voltage generation unit depending upon a driving mode.

Due to this fact, since a voltage drop phenomenon occurs by the resistance of the switches, difficulties exist in transmitting gamma reference voltages with target levels.

In consideration of this situation, while the voltage drop phenomenon can be suppressed to some extent by increasing the size of the switches, a problem is caused in that the switches occupy a substantial portion of a layout.

Moreover, in the case where the resistance values of the resistor strings of the gamma voltage generation units are designed to be small, difficulties exist in generating precise gamma voltage values due to a voltage drop.

### SUMMARY OF THE INVENTION

Accordingly, the present invention has been made in an effort to solve the problems occurring in the related art, and an object of the present invention is to provide a gamma reference voltage output circuit of a source driver which can selectively output gamma reference voltages to an IPS gamma voltage generation unit and a TN gamma voltage generation unit without causing a voltage drop when outputting the gamma reference voltages from gamma buffers.

The present invention is not limited to such an object. Other objects and advantages of the present invention will be more apparently understood from the following descriptions.

In order to achieve the above object, according to one aspect of the present invention, there is provided a gamma reference voltage output circuit of a source driver, including: a reference voltage generation unit configured to divide power supply voltages by using resistors which are connected in series, and generate a plurality of gamma reference voltages; a gamma buffer unit having a plurality of gamma buffers which selectively output, through internal switching operations, gamma reference voltages needed by a plurality of gamma voltage generation units; and the plurality of gamma voltage generation units configured to divide the gamma reference voltages which are inputted from the gamma buffer unit, by using resistors which are connected in series, in conformity with a required mode and output divided gamma voltages.

According to another aspect of the present invention, the gamma buffers include an IPS gamma reference voltage output section constituted by first and second MOS transistors and configured to output gamma reference voltages for an IPS mode; a TN gamma reference voltage output section constituted by third and fourth MOS transistors and configured to output gamma reference voltages for a TN mode; first through fourth switches configured to select and operate the IPS gamma reference voltage output section; and fifth through eighth switches configured to select and operate the TN gamma reference voltage output section.

### BRIEF DESCRIPTION OF THE DRAWINGS

The above objects, and other features and advantages of the present invention will become more apparent after a reading of the following detailed description taken in conjunction with the drawings, in which:

FIG. 1 is a block diagram illustrating a conventional source driver circuit;

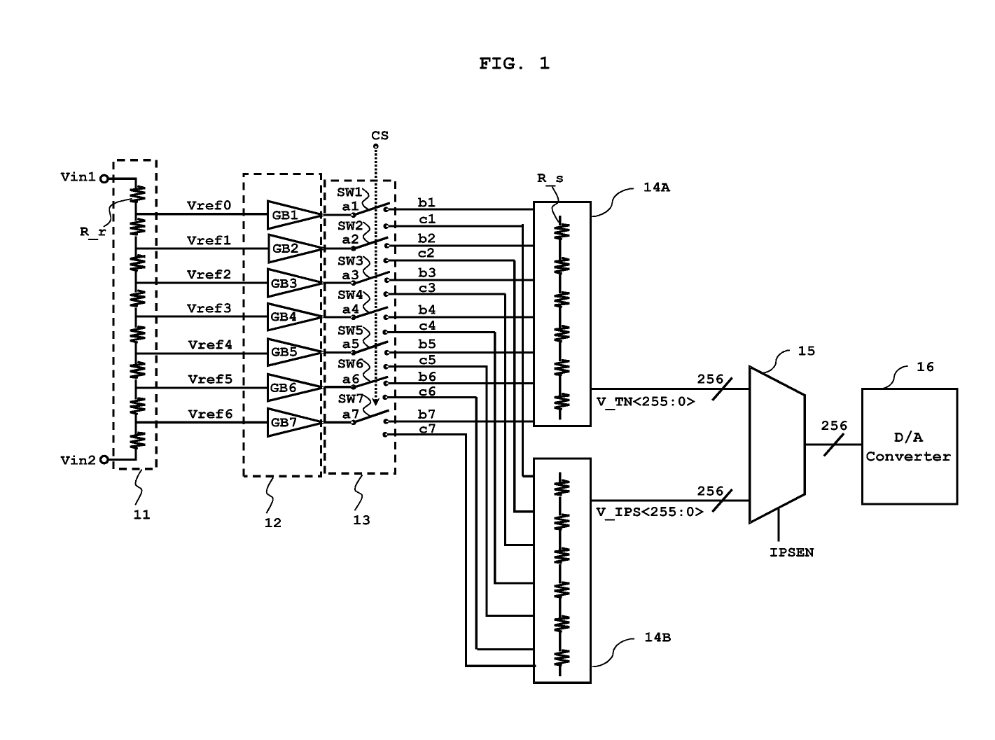

FIG. 2 is a circuit diagram illustrating the output stage of a gamma buffer in the conventional source driver circuit;

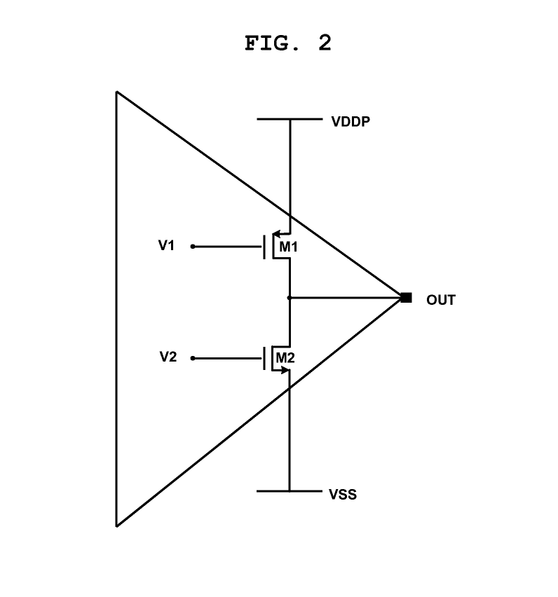

FIG. 3 is a block diagram illustrating a gamma reference voltage output circuit of a source driver in accordance with an embodiment of the present invention;

FIG. 4 is a circuit diagram illustrating the output stage of a gamma buffer in the gamma reference voltage output circuit according to the present invention;

FIG. 5 is an equivalent circuit diagram of FIG. 4 in an IPS gamma voltage mode; and

FIG. 6 is an equivalent circuit diagram of FIG. 4 in a TN gamma voltage mode.

### DETAILED DESCRIPTION OF PREFERRED EMBODIMENTS

Reference will now be made in greater detail to a preferred embodiment of the invention, an example of which is illustrated in the accompanying drawings. Wherever possible, the same reference numerals will be used throughout the drawings and the description to refer to the same or like parts.

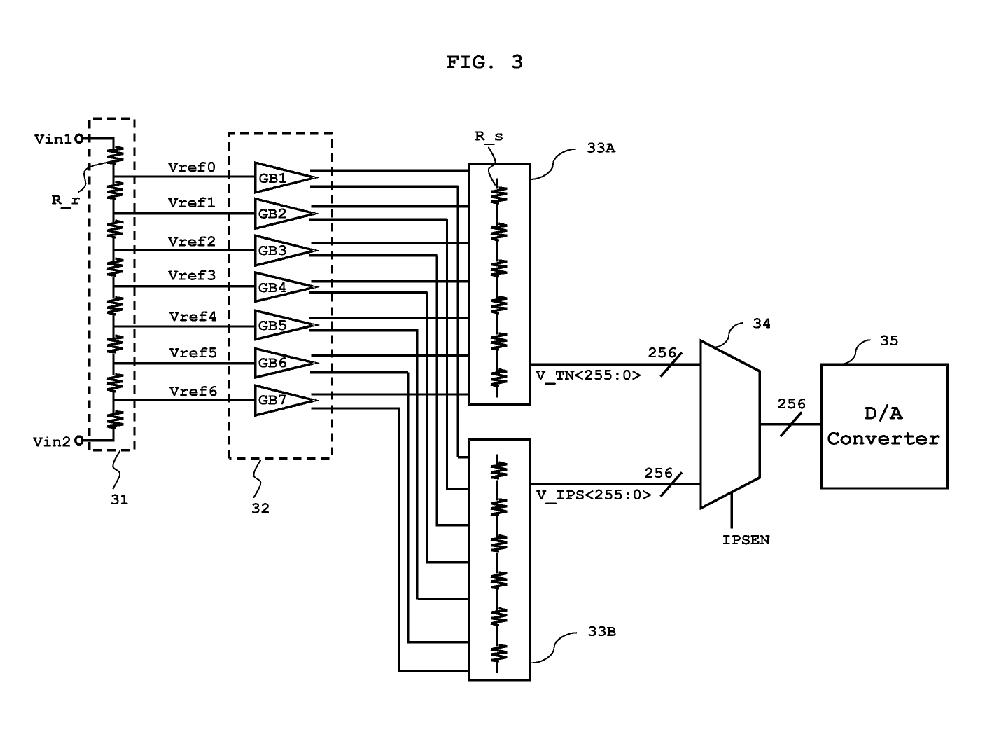

FIG. 3 is a block diagram illustrating a gamma reference voltage output circuit of a source driver in accordance with an embodiment of the present invention.

Referring to FIG. 3, a gamma reference voltage output circuit of a source driver in accordance with an embodiment of the present invention includes a reference voltage generation unit 31, a gamma buffer unit 32, a TN gamma voltage generation unit 33A, an IPS gamma voltage generation unit 33B, a multiplexer 34, and a D/A converter 35.

The reference voltage generation unit 31 has resistors R_r which are connected in series, and is configured to divide a voltage difference between power supply voltages Vin1 and Vin2 by the resistors R_r and generate a plurality of gamma reference voltages Vref0 through Vref6.

The gamma buffer unit 32 has a plurality of gamma buffers GB1 through GB7, and is configured to stabilize and output the gamma reference voltages Vref0 through Vref6 which are outputted from the reference voltage generation unit 31. Each of the gamma buffers GB1 through GB7 has two output terminals which are connected to the TN gamma voltage generation unit 33A and the IPS gamma voltage generation unit 33B. While each of the gamma buffers GB1 through GB7 is illustrated as having only one input terminal, each of the gamma buffers GB1 through GB7 may be realized by an operational amplifier having an input terminal which is connected to a non-inverting input terminal and an output terminal which is connected to an inverting input terminal.

Each of the TN gamma voltage generation unit 33A and the IPS gamma voltage generation unit 33B has resistors R_s which are connected in series. The TN gamma voltage generation unit 33A and the IPS gamma voltage generation unit 33B are configured to divide the gamma reference voltages Vref0 through Vref6, which are inputted from the gamma buffer unit 32, in conformity with a TN (twisted nematic) mode and an IPS (in-plane switching) mode, and output divided gamma voltages V_TN<255:0> and V_IPS<255:0>.

The multiplexer 34 is configured to select and output the gamma voltages V_TN<255:0> which are outputted from the TN gamma voltage generation unit 33A or the gamma voltages V_IPS<255:0> which are outputted from the IPS gamma voltage generation unit 33B, according to a mode select signal IPSEN. The mode select signal IPSEN is a signal which indicates whether a liquid crystal display device operates in the IPS mode or the TN mode, and can be changed in the logic state thereof depending upon an operation mode. For example, the mode select signal IPSEN may be enabled when the liquid crystal display device operates in the IPS mode and disabled when the liquid crystal display device operates in the TN mode. A mode select bar signal IPSENB is a mode select signal which has a logic state opposite to that of the mode select signal IPSEN.

The D/A converter 35 is configured to select and output the analog gamma voltages V_TN<255:0> and V_IPS<255:0> which are generated through the paths as described above, in correspondence to R, G and B data which are inputted from a controller.

The gamma buffers GB1 through GB7 of the gamma buffer unit 32 output the gamma reference voltages which are needed by the TN gamma voltage generation unit 33A or the IPS gamma voltage generation unit 33B, through internal switching operations. This will be described below in detail.

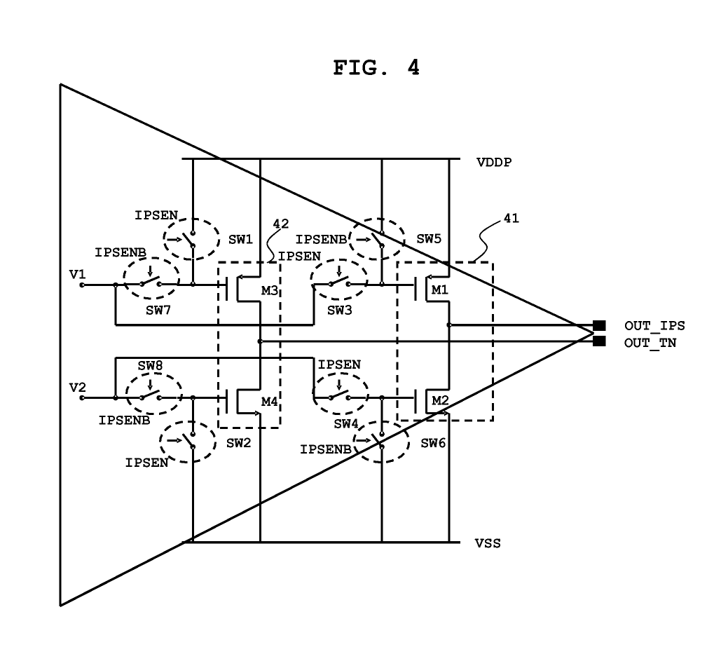

The gamma buffers GB1 through GB7 are realized by operational amplifiers. FIG. 4 illustrates the circuit of the output stage of an operational amplifier. An input stage and a summing stage may be disposed at the front end of the output stage. In the present embodiment, the output stage of the operational amplifier may include an IPS gamma reference voltage output section 41, a TN gamma reference voltage output section 42, and switches SW1 through SW8. Since the input stage and the summing stage as the circuits of the front end of the output stage can be easily understood from the following explanation of the IPS gamma reference voltage output section 41, the TN gamma reference voltage output section 42, and the switches SW1 through SW8, detailed descriptions of the input stage and the summing stage will be omitted.

Referring to FIG. 4, each of the gamma buffers GB1 through GB7 includes the IPS gamma reference voltage output section 41 which is constituted by MOS transistors M1 and M2 and is configured to output gamma reference voltages to the IPS gamma voltage generation unit 33B; the TN gamma reference voltage output section 42 which is constituted by MOS transistors M3 and M4 and is configured to output gamma reference voltages to the TN gamma voltage generation unit 33A; the first through fourth switches SW1 through SW4 which are configured to select and operate the IPS gamma reference voltage output section 41; fifth through eighth switches SW5 through SW8 which are configured to select and output the TN gamma reference voltage output section 42; an output terminal OUT_IPS which is connected to the IPS gamma reference voltage output section 41; and an output terminal OUT_TN which is connected to the TN gamma reference voltage output section 42.

The IPS gamma reference voltage output section 41 includes the first MOS transistor M1 having the source terminal which is connected to a power supply terminal VDDP, the drain terminal which is connected to the output terminal OUT_IPS of the gamma reference voltages and the gate terminal which is connected to a first output terminal V1 of the summing stage; and the second MOS transistor M2 having the source terminal which is connected to a power supply terminal VSS, the drain terminal which is connected to the output terminal OUT_IPS of the gamma reference voltages and the gate terminal which is connected to a second output terminal V2 of the summing stage. The first output terminal V1 and the second output terminal V2 of the summing stage provide signals for push or pull operations of PMOSes and NMOSes constituting the IPS gamma reference voltage output section 41 and the TN gamma reference voltage output section 42, using signal differences between the gamma reference voltages inputted to the input stage and feedback voltages.

The TN gamma reference voltage output section 42 includes the third MOS transistor M3 having the source terminal which is connected to the power supply terminal VDDP, the drain terminal which is connected to the output terminal OUT_TN of the gamma reference voltages and the gate terminal which is connected to the first output terminal V1 of the summing stage; and the fourth MOS transistor M4 having the source terminal which is connected to the power supply terminal VSS, the drain terminal which is connected to the output terminal OUT_TN of the gamma reference voltages and the gate terminal which is connected to the second output terminal V2 of the summing stage.

The first switch SW1 is connected between the power supply terminal VDDP and the gate terminal of the third MOS transistor M3, the second switch SW2 is connected between the gate terminal of the fourth MOS transistor M4 and the power supply terminal VSS, the third switch SW3 is connected between the gate terminal of the first MOS transistor M1 and the first output terminal V1 of the summing stage, and the fourth switch SW4 is connected between the gate terminal of the second MOS transistor M2 and the second output terminal V2 of the summing stage.

The fifth switch SW5 is connected between the power supply terminal VDDP and the gate terminal of the first MOS transistor M1, the sixth switch SW6 is connected between the gate terminal of the second MOS transistor M2 and the power supply terminal VSS, the seventh switch SW7 is connected between the first output terminal V1 of the summing stage and the gate terminal of the third MOS transistor M3, and the eighth switch SW8 is connected between the second output terminal V2 of the summing stage and the gate terminal of the fourth MOS transistor M4. The first through eighth switches SW1 through SW8 may be realized by MOS transistors.

Hereafter, a method for driving the gamma buffers GB1 through GB7 in accordance with the embodiment of the present invention will be described. The inverted mode select signal IPSENB is a mode select signal which has a logic state opposite to that of the mode select signal IPSEN.

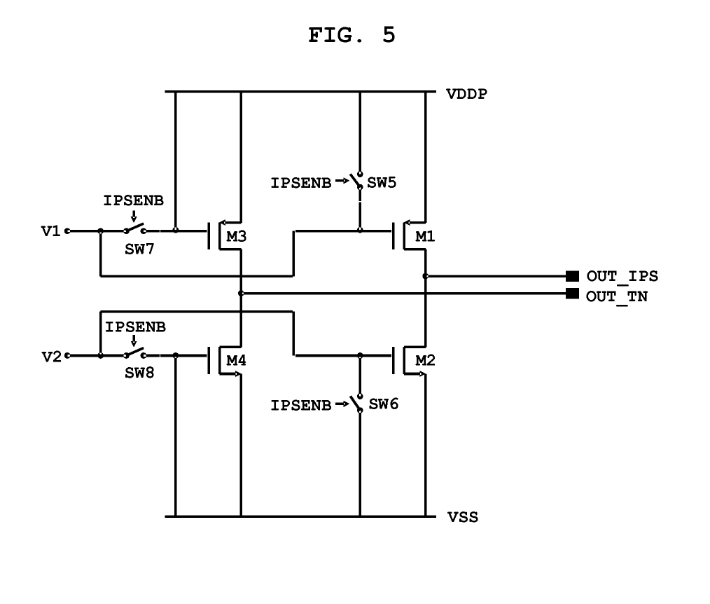

First, if the mode select signal IPSEN is outputted from the controller (for example, a timing controller) by being enabled to a high level, according to an IPS gamma voltage mode, the first through fourth switches SW1 through SW4 are turned on, and the fifth through eighth switches SW5 through SW8 are turned off. According to this fact, the circuit shown in FIG. 4 operates as shown in FIG. 5 such that the IPS gamma reference voltage output section 41 operates to output the gamma reference voltages to the IPS gamma voltage generation unit 33B. Accordingly, the gamma reference voltages are outputted to the IPS gamma voltage generation unit 33B from the gamma buffers GB1 through GB7 of the gamma buffer unit 32 through output terminals OUT_IPS.

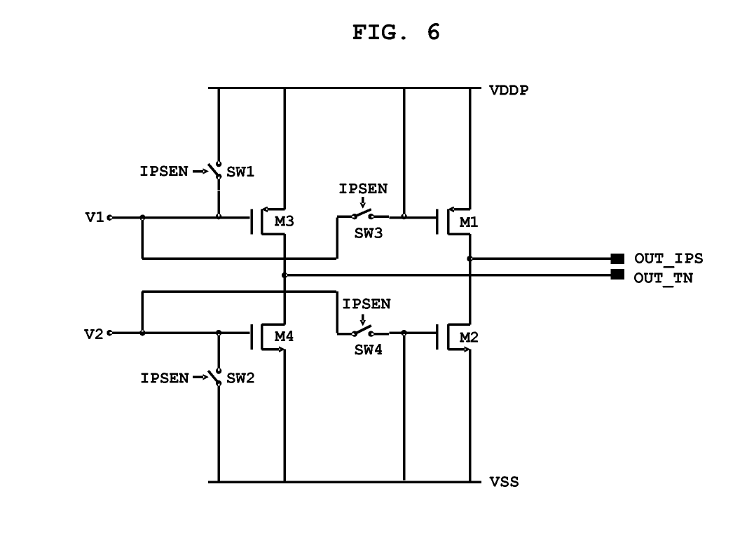

If the mode select signal IPSEN is outputted from the controller by being disabled to a low level, according to a TN gamma voltage mode, the first through fourth switches SW1 through SW4 are turned off, and the fifth through eighth switches SW5 through SW8 are turned on. According to this fact, the circuit shown in FIG. 4 operates as shown in FIG. 6 such that the TN gamma reference voltage output section 42 operates to output the gamma reference voltages to the TN gamma voltage generation unit 33A. Accordingly, the gamma reference voltages are outputted to the TN gamma voltage generation unit 33A from the gamma buffers GB1 through GB7 of the gamma buffer unit 32 through output terminals OUT_TN.

While it is preferred that the first through fourth switches SW1 through SW4 and the fifth through eighth switches SW5 through SW8 are realized by MOS transistors, it is to be noted that the present invention is not limited to such.

While it was exemplified in the present embodiment that necessary gamma voltages are generated in the case where a liquid crystal display device operates in an IPS mode and a TN mode, the present invention is not limited to such. Therefore, it is to be noted that the present invention can be applied to another display device in which a gamma buffer unit switches gamma reference voltages and provides the gamma reference voltages to a corresponding mode gamma voltage generation unit when the display device has different gamma voltage characteristics depending upon an operation mode.

As is apparent from the above description, the present invention provides advantages in that, since gamma reference voltages can be selectively outputted to an IPS gamma voltage generation unit and a TN gamma voltage generation unit depending upon a selected mode when outputting the gamma reference voltages from gamma buffers, a voltage drop does not occur in the outputted gamma reference voltages, whereby it is possible to output voltages of desired levels.

Also, because switches for selectively outputting the IPS/TN gamma reference voltages are disposed not outside the gamma buffers but inside the gamma buffers, the switches can be designed to have a minimum size.

Although a preferred embodiment of the present invention has been described for illustrative purposes, those skilled in the art will appreciate that various modifications, additions and substitutions are possible, without departing from the scope and the spirit of the invention as disclosed in the accompanying claims.

What is claimed is:

1. A gamma reference voltage output circuit of a source driver, comprising:
a reference voltage generation unit configured to divide power supply voltages by using resistors which are connected in series, and generate a plurality of gamma reference voltages;
a gamma buffer unit having a plurality of gamma buffers which selectively output, through internal switching operations, gamma reference voltages needed by a plurality of gamma voltage generation units; and
the plurality of gamma voltage generation units configured to divide the gamma reference voltages which are inputted from the gamma buffer unit, by using resistors which are connected in series, in conformity with a required mode and output divided gamma voltages.

2. The gamma reference voltage output circuit according to claim 1, wherein the plurality of gamma voltage generation units comprise a gamma voltage generation unit which is configured to generate gamma voltages needed for a TN (twisted nematic) mode operation and a gamma voltage generation unit which is configured to generate gamma voltages needed for an IPS (in-plane switching) mode operation.

3. The gamma reference voltage output circuit according to claim 1, wherein the gamma buffers comprise:
an IPS gamma reference voltage output section constituted by first and second MOS transistors and configured to output gamma reference voltages for an IPS mode;
a TN gamma reference voltage output section constituted by third and fourth MOS transistors and configured to output gamma reference voltages for a TN mode;
first through fourth switches configured to select and operate the IPS gamma reference voltage output section; and
fifth through eighth switches configured to select and operate the TN gamma reference voltage output section.

4. The gamma reference voltage output circuit according to claim 3, wherein the IPS gamma reference voltage output section comprises:
the first MOS transistor having a source terminal which is connected to a first power supply terminal, a drain terminal which is connected to an output terminal of the gamma reference voltages, and a gate terminal which is connected to a first output terminal of a summing stage; and
the second MOS transistor having a source terminal which is connected to a second power supply terminal, a drain terminal which is connected to the output terminal of the gamma reference voltages, and a gate terminal which is connected to a second output terminal of the summing stage.

5. The gamma reference voltage output circuit according to claim 3, wherein the TN gamma reference voltage output section comprises:
the third MOS transistor having a source terminal which is connected to the first power supply terminal, a drain terminal which is connected to the output terminal of the gamma reference voltages, and a gate terminal which is connected to the first output terminal of the summing stage; and
the fourth MOS transistor having a source terminal which is connected to the second power supply terminal, a drain terminal which is connected to the output terminal of the gamma reference voltages, and a gate terminal which is connected to the second output terminal of the summing stage.

6. The gamma reference voltage output circuit according to claim 3, wherein the first switch is connected between the first power supply terminal and the gate terminal of the third MOS transistor, the second switch is connected between the gate terminal of the fourth MOS transistor and the second power supply terminal, the third switch is connected between the gate terminal of the first MOS transistor and the first output terminal of the summing stage, and the fourth switch is connected between the gate terminal of the second MOS transistor and the second output terminal of the summing stage.

7. The gamma reference voltage output circuit according to claim 3, wherein the fifth switch is connected between the first power supply terminal and the gate terminal of the first MOS transistor, the sixth switch is connected between the gate terminal of the second MOS transistor and the second power supply terminal, the seventh switch is connected between the first output terminal of the summing stage and the gate terminal of the third MOS transistor, and the eighth switch is connected between the second output terminal of the summing stage and the gate terminal of the fourth MOS transistor.

8. The gamma reference voltage output circuit according to claim 3, wherein the first through eighth switches comprise MOS transistors.

9. A gamma reference voltage output circuit of a source driver, comprising:
gamma buffers configured to switch gamma reference voltages according to a mode select signal and output the gamma reference voltages through one selected between a first output terminal and a second output terminal;
a first gamma voltage generation unit connected to the first output terminal, and configured to divide the gamma reference voltages and output gamma voltages which are to be used in a first mode; and
a second gamma voltage generation unit connected to the second output terminal, and configured to divide the gamma reference voltages and output gamma voltages which are to be used in a second mode.
